(19) United States
(12) Patent Application Publication
(10) Pub. No.: US 2005/0181663 A1
(43) Pub. Date: Aug. 18, 2005

(54) Plug bridge comprising a hollow pin

(76) Inventors: Thomas Waible, Waldbronn (DE); Jorg Vetter, Ispringen (DE)

Correspondence Address: BAKER & DANIELS LLP;111 E. WAYNE STREET, SUITE 800, FORT WAYNE, IN, 46802, US

(21) Appl. No.: 10/512,516

(22) PCT Filed: Apr. 28, 2003
(86) PCT No.: PCT/DE03/01374

(30) Foreign Application Priority Data
Apr. 26, 2002 (DE) 102 18 865.3

(51) Int. Cl. H01R 13/52

(52) U.S. Cl. 439/519

(57) ABSTRACT

The invention relates to a plug bridge comprising a base plate and a hollow pin that penetrates said base plate. The hollow space of the hollow pin, which is open at the socket end, is provided with a seal in order to prevent any base plate material from penetrating into it during the manufacture of the plug bridge.

The present invention relates to the subject of the pre-characterizing clause. Thus, the present invention relates to plug bridges.

A plug bridge is a component of a power plug, in which is established the connection between the contacts to be inserted into a wall socket, i.e., the ground connection and/or the plug pins on the one side, and the insulated strands of a power cable on the other. The plug bridge encloses the plug pins in a geometrical orientation as prescribed by the relevant electrical code, and—on its strand connection end—has a simple connection device, such as a crimp wing, to be crimped with the leads, solder tails, lead-in funnels for crimping, bolt connections, etc.

There already exist plug bridge arrangements used to connect with power cables in which hollow space is used, i.e., plug pins that are stamped and cut from metal sheet and/or bent and/or their insides comprise hollow space. This is advantageous as such, because hollow space can be produced with less material and in a shorter amount of time than it takes to manufacture plug pins whose form must be turned from full, non-hollow material. An additional advantage of the hollow design is that it weighs less and is consequently easier to handle, transport, etc.

However, the advantage of hollow pins is more than outweighed by problems inherent to their design. In addition, it is not possible to use hollow pin contacts in waterproof plugs. According to current safety regulations, synthetic material of the plug bridge must not penetrate into the hollow space of the plug pin. During the process of spray coating the hollow-pin, the plug contacts with a synthetic material that forms the plug bridge, and since this danger exists, the current state of the art requires that the hollow pins be built into the plug bridge base plate after it has been manufactured. This means that water or moisture in the hollow space of the pin can travel up to the strands of the power cable and cause the contacts to corrode, which impairs the long-term stability of the plug and thus prevents the plug from being used in outdoor applications, in humid spaces, and similar environments.

The task of the present invention is to provide a technical novelty for industrial use.

This task is resolved in an independent form. Preferred further developments are claimed in dependent claims.

As the first basic concept, the present invention proposes a plug bridge comprising a base plate and a hollow pin that penetrates this base plate, wherein the hollow space of the hollow pin, which is open at the socket end, is provided with a seal in order to prevent any base plate material from penetrating into it during the manufacture of the plug bridge.

Thus, the first essential aspect of the present invention consists in the fact that a seal introduced into the hollow pin during its manufacture prevents the base plate material from penetrating into the hollow space—which is open at the socket end—during the manufacture of the plug bridge. The provision of the seal during the manufacture of the hollow pin does not pose any problems, and allows for a fast manufacturing process, so that the seal increases the manufacturing costs by only a small amount. However, this miniscule cost increase is more than outweighed by the beneficial fact that the hollow pin can be fully enveloped during the molding of the base plate.

Therefore, the base plate is preferably molded and/or injection-molded. This can be done in a conventional form, while leaving a lead-in funnel for the lead end to be connected through a crimp pipe, and another lead-in funnel for the lead end of the ground connection, etc. In this connection we wish to point out that a plug bridge according to this invention already exists, if only a single hollow pin of the described type is provided in the plug bridge; in typical 220V safety plugs, both hollow pins are usually fitted with the aforementioned seal. In these plugs, round hollow pins are fitted with a seal; however, we must point out that such seals can also be used for angular pins.

The hollow pins can be manufactured by bending up stamped and/or embossed metal sheets, in which case there is then a gap in the area close to the plug, into which moisture or similar element can penetrate. However, this moisture cannot penetrate all the way into the inside of the plug itself, because the hollow pin is fully enveloped by the base plate material and, after the base plate is manufactured, this material ensures that the hollow pin is hermetically sealed.

In a preferred form, the seal is formed by a little plate built into the hollow space. Since this little plate has contact with the entire inside space of the hollow pin, it is even more stabilized during the spray-molding process. Thus, another special advantage of the invention is an increase in the form stability and, therefore, in the safety of its operation.

The little plate can be fixed by a circumferential knurl and/or an embossed edge. Alternatively, clinched tabs can be used to fix the sealing plate.

In an especially preferred variant, the seal, i.e., the little plate, is made of the same material as the hollow pin. This is advantageous, because the base plate material is usually molded while hot, and the selection of the same material prevents different expansion coefficients from destroying the seal during the manufacturing of the base plate.

It is further preferred that the seal is fixed close to the surface of the base plate on the side of the plug, and also that lateral apertures are arranged in the hollow pin's wall. These apertures are located closer to the connection with the power cable, but are still in the area of the base plate, so that, during the manufacturing of the base plate, the base plate material can penetrate into the hollow pin as far as the seal and, after solidifying, will prevent the pin from twisting. Alternatively and/or in addition, the protection against twisting can be enhanced by the design of the crimp connection.

In the following text, the invention will be explained using an example and drawings.

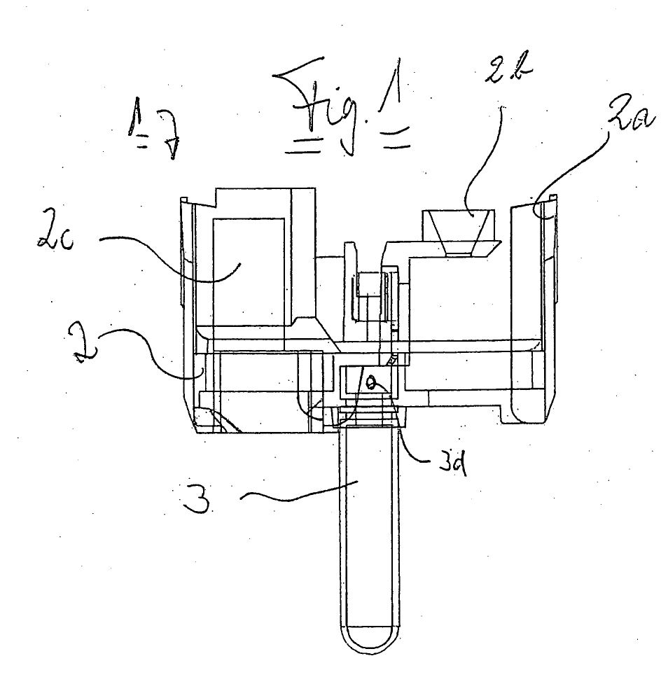

FIG. 1 shows a sectional view through a plug bridge with hollow pins as designed by the invention;

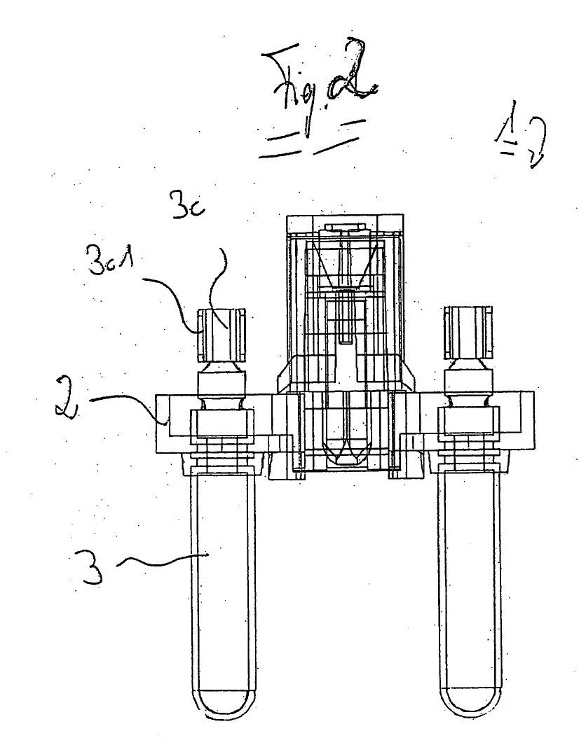

FIG. 2 shows a sectional view at a different plane;

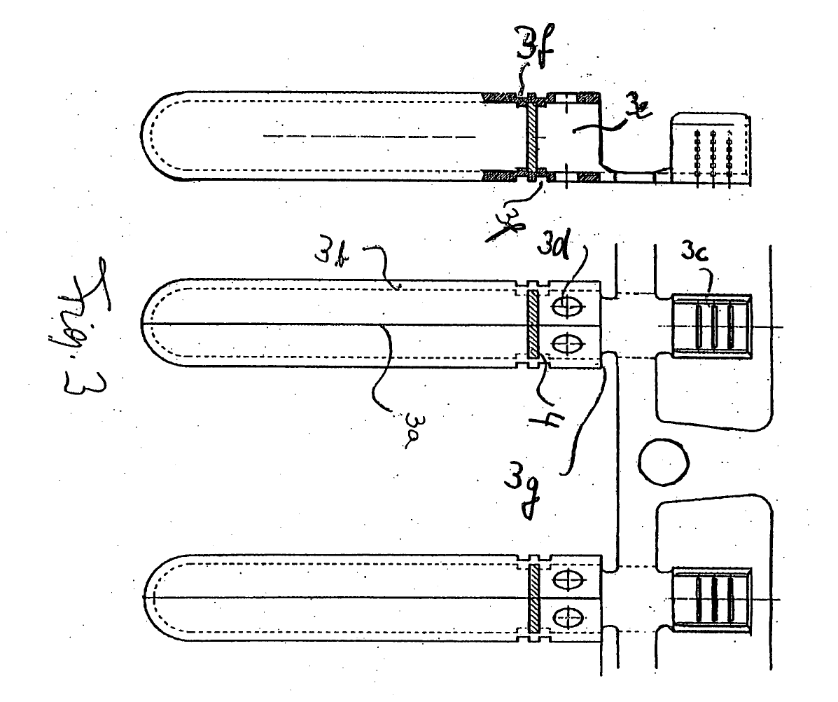

FIG. 3 shows an example of a band with the hollow pins as designed by the invention;

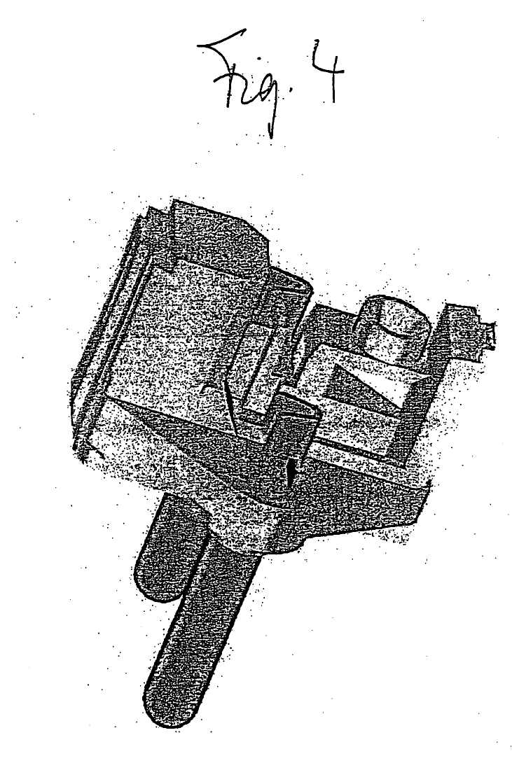

FIG. 4 shows a perspective view of a plug bridge as designed by the invention;

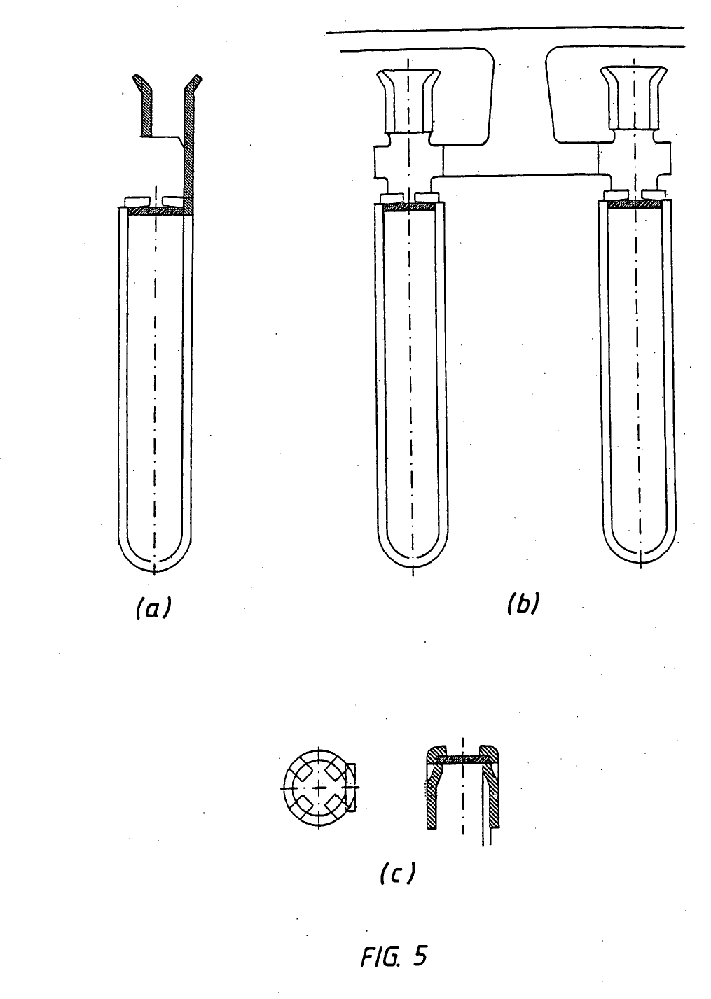

FIG. 5 shows another exemplary design of a plug pin.

As shown in FIG. 1, a plug bridge 1—generally denoted with 1—comprises a base plate 2 and hollow pins 3 that penetrate said base plate. The hollow space of the hollow pin, which is open—through a slot 3a (See FIG. 3)—at the socket end, is provided with a seal 4 in order to prevent any base plate material from penetrating into it during the manufacture of the plug bridge.

The plug bridge base plate 2 is made of a fiber-reinforced, non-conductive synthetic material and generally has a U-shape cross-section. The U-shaped branches 2a that extend towards the grip body of the plug can be fitted with attachment elements for a ground connection clip (not shown). Lead-in funnels 2b can be provided in the base plate above the connection points and between the ground contact clip and/or the connection ends of the hollow pins 3 on the one side, and the power cable strands on the other side. These lead-in funnels can be molded as one piece with the base plate or can be inserted into it. A hollow space 2c can be provided to contain the ground connection pin or a similar element in order to connect with properly standardized plugs.

The hollow pin 3 is made of a metal sheet band. During the manufacturing process, the metal sheet band contains a whole number of hollow pins, as is shown in FIG. 3 (2 hollow pins in top view). The shown hollow pin 3a has a wall 3b made of metal sheet material that comprises apertures 3d, which are close to the connection point 3c for the connection of the power cable, and are located above the seal 4. These apertures are sufficiently large for the base plate material when hot, and of a viscosity sufficient to penetrate, during the manufacturing of the plug bridge, into the space 3e that is visible in the cross-section view of a hollow pin in FIG. 3. In the area of the seal 4, the wall 3b of the hollow pin 3 is curled along its entire circumference as is made visible by the recess 3f. We wish to point out that the dimensions shown in the drawings do not limit the patent protection, but are to be taken only as an example. The seal 4 is made of the same material as the electrically conductive hollow pin.

The plug bridge is manufactured as follows:

First, the hollow pin is made of a sheet metal band, and the little round plates 4 are built in during the stamping and folding process.

The thus obtained metal sheet band (with completed hollow pins) is then divided into individual hollow pins, and these are spray-coated with the hot material of the base plate in the area of the cover 4 up to the edge 3g on its side towards the power cable connection point 3c. The base plate material fully encloses the hollow pin, penetrates into the space 3e, and overlaps it. Due to the fact that the sealing plate 4 is sealed by the recess 3f, the hot base plate material cannot penetrate the hollow space past the seal 4 during the manufacturing process.

After the base plate hardens and the ground connection spring bracket is mounted, a power cable can be connected, which is done in the shown example design using crimping at the crimp wings 3c1 on the side 3c. In other designs, this is achieved by soldering, bolting, or similar fastening procedures. Afterwards, the grip body is spray-coated with PVC or a similar material so that the contact zone between the strand connection end 3c and the power cable end is completely enveloped and hermetically sealed from the outside environment with no danger that moisture will penetrate past the sealing plate and into the inside space of the grip body. In addition, the base plate material firmly rests against the seal and thus creates a sealed base plate surface that is nearly absolutely vapor-tight. A plug that comprises a hollow pin and/or a plug bridge as designed by the invention and/or which has been fabricated according to the invented method, is ideally suited for use in a humid environment, outdoors, etc., although hollow pins are used instead of pins turned out of full material.

According to FIG. 5, the seal in the form of a cover plate is provided on the upper end of the hollow pin. The cover plate rests on an edge zone slightly curled, pressed inside, or embossed, and is then fixed from above by tabs. This manufacturing technique is simple and eliminates weight.

1. Plug bridge comprising a base plate and a hollow pin that penetrates said base plate, characterized in that the hollow space of the hollow pin, which is open at the socket end, is provided with a seal in order to prevent any base plate material from penetrating into it during the manufacture of the plug bridge.

2. Plug bridge according to claim 1, characterized in that the base plate is molded and/or injection-molded.

3. Plug bridge according to claim 2, characterized in that the hollow pin is fully enveloped by spray molding in the area of the base plate level.

4. Plug bridge according to claim 1, characterized in that the hollow pin is folded from a stamped and/or embossed piece of metal sheet.

5. Plug bridge according to claim 1, characterized in that the seal is designed as a small plate built into the hollow space.

6. Plug bridge according to claim 1, characterized in that the small plate is fixed by means of a circumferential embossed edge, and particularly between two such edges.

7. Plug bridge according to claim 1, characterized in that the small plate is made of the same material as the hollow pin.

8. Plug bridge according to claim 1, characterized in that, between the seal and the part of the hollow pin that protrudes over the base plate, at least one lateral aperture is provided in the wall of the hollow pin in order to facilitate the penetration of the base plate material up to the seal, so as to enhance its protection against twisting.

9. Plug bridge according to claim 1, characterized in that the seal is provided at the end of the hollow pin that is adjacent to the crimp connection.

10. Hollow pin for a plug bridge according to claim 1.

11. Plug bridge according to claim 2, characterized in that the hollow pin is folded from a stamped and/or embossed piece of metal sheet.

12. Plug bridge according to claim 3, characterized in that the hollow pin is folded from a stamped and/or embossed piece of metal sheet.

13. Plug bridge according to claim 2, characterized in that the seal is designed as a small plate built into the hollow space.

14. Plug bridge according to claim 3, characterized in that the seal is designed as a small plate built into the hollow space.

15. Plug bridge according to claim 4, characterized in that the seal is designed as a small plate built into the hollow space.

16. Plug bridge according to claim 2, characterized in that the small plate is fixed by means of a circumferential embossed edge, and particularly between two such edges.

17. Plug bridge according to claim 3, characterized in that the small plate is fixed by means of a circumferential embossed edge, and particularly between two such edges.

18. Plug bridge according to claim 4, characterized in that the small plate is fixed by means of a circumferential embossed edge, and particularly between two such edges.

19. Plug bridge according to claim 5, characterized in that the small plate is fixed by means of a circumferential embossed edge, and particularly between two such edges.

20. Plug bridge according to claim 2, characterized in that the small plate is made of the same material as the hollow pin.
